(19) United States
(12) Patent Application Publication
(10) Pub. No.: US 2024/0312667 A1
(43) Pub. Date: Sep. 19, 2024

(54) Cable comprising a recyclable polymer layer

(71) Applicant: NEXANS, Courbevoie (FR)

(72) Inventors: Jean-Francois LARCHE, FLEURIEU-SUR-SAÔNE (FR); Lucile SLAWINSKI, TERNAY (FR); Benjamin MULOT, Villeurbanne (FR)

(21) Appl. No.: 18/399,125

(22) Filed: Dec. 28, 2023

(30) Foreign Application Priority Data
Dec. 30, 2022 (FR) 2214692

(51) Int. Cl. H01B 3/00; C08J 7/04; C08K 5/07; H01B 3/22; H01B 3/44

(52) U.S. Cl. CPC H01B 3/002; C08J 7/04; C08K 5/07; C08J 2207/06; C08J 2323/14; C08J 2423/06; C08J 2423/16; H01B 3/22; H01B 3/441

(57) ABSTRACT

An electrical cable has at least one elongate conductive element surrounded by a recyclable thermoplastic layer. The recyclable thermoplastic layer has at least a composite material (TPV) having a thermoplastic polymer matrix (a); and a vulcanized elastomer phase (b) dispersed within said thermoplastic matrix (a); and a polyethylene.

### RELATED APPLICATION

The present application claims the benefit of priority from French Patent Application No. 22 14692, filed on Dec. 30, 2022, the entirety of which is incorporated by reference.

### FIELD OF THE INVENTION

The present invention relates to the field of electrical devices of the electrical cable or accessories for electrical cables type and which comprise at least one recyclable polymer layer. “Polymer layer” is understood here as meaning a coating based on at least one polymer.

The invention applies typically, but not exclusively, to the fields of low-voltage (in particular less than 6 kV) or medium-voltage (in particular 6 to 45-60 kV) power cables for either direct or alternating current.

### DESCRIPTION OF RELATED ART

Power cables typically comprise a central electrical conductor, generally at least one elongate electrically conductive element, such as wire or strand of wires, and at least one electrically insulating layer surrounding this central conductive element. Optionally, a power cable may further comprise at least one semiconductive layer, which may for example be, depending on the applications envisaged:
possibly an inner semiconductive layer situated between the electrically insulating layer and the central conductive element (where the inner semiconductive layer, if present, surrounds the central conductive element and the electrically insulating layer encloses the inner semiconductive layer); and/or
possibly an outer semiconductive layer surrounding said electrically insulating layer.

Conventionally, these layers are produced from crosslinked polymers, in particular ones based on a crosslinked polyolefin such as a crosslinked polyethylene (XLPE) or on a crosslinked elastomer, for example a crosslinked ethylene-propylene-diene (EPDM). The use of crosslinked polymers is a well known way of improving certain properties of the layers, in particular their mechanical and thermal properties. However, the crosslinking of the polymers poses a particular problem, namely that it makes recycling of the polymer layers very difficult (and often even impossible in practice).

More recently, it has been proposed, inter alia in patent application WO 2018167442, to use polypropylene-based layers, which have the advantage of not having to be crosslinked and which thus open up the possibility of easier recycling. Polypropylene-based layers generally have good dielectric properties, but mechanical and thermal properties that are less advantageous than those of crosslinked layers. In particular, the low density of polypropylene is associated with thermal conductivity properties inferior to those of polyethylene, which is a disadvantage particularly for medium- or high-voltage power cables: this lower thermal conductivity reduces the dissipation of the heat generated by the Joule heating effect, which adversely affects the amount of power that can be carried by the cable.

### OBJECTS AND SUMMARY

An aim of the present invention is to provide cables that comprise one or more recyclable insulating or semiconductive layers and that have good dielectric, mechanical and thermal properties.

To this end, the present invention proposes to employ within these layers a mixture of a composite material known as TPV (thermoplastic vulcanizate) and a polyethylene.

More specifically, according to a first aspect, the present invention provides an electrical cable comprising at least one elongate conductive element surrounded by a recyclable thermoplastic layer comprising at least
a composite material (also referred to hereinafter as “TPV” for conciseness) comprising:
(a) a thermoplastic polymer matrix; and
(b) a vulcanized elastomer phase dispersed within said thermoplastic matrix (a); and
a polyethylene.

According to a preferred embodiment, the dispersed vulcanized elastomer phase (b) comprises a crosslinked ethylene-propylene-diene elastomer (EPDM). The dispersed vulcanized elastomer phase (b) advantageously consists solely of a vulcanized EPDM elastomer.

Alternatively, other crosslinked elastomers may be present in the vulcanized elastomer phase (b), alone or as a mixture with EPDM, for example a crosslinked ethylene-propylene elastomer.

In addition, it is advantageous for the thermoplastic matrix (a) to comprise a polyolefin. “Polyolefin” is understood here as meaning a copolymer or homopolymer of an olefin, preferably of a non-cyclic olefin such as ethylene or propylene. The thermoplastic matrix (a) advantageously comprises a propylene homopolymer or copolymer, for example a polypropylene homopolymer. According to a preferred embodiment, the matrix (a) consists solely of a polypropylene homopolymer.

Thus, according to an advantageous embodiment, the TPV composite material comprises a polypropylene-based matrix (a) in which is dispersed a phase (b) based on a crosslinked EPDM. It may for example be a matrix (a) consisting solely of polypropylene in which is dispersed a dispersed phase (b) consisting solely of crosslinked EPDM.

According to an advantageous variant of the invention, the recyclable thermoplastic layer comprising the TPV and the polyethylene may further comprise a propylene copolymer (c), which is preferably a copolymer of propylene and an alpha-olefin other than propylene.

In addition, irrespective of whether an additional propylene copolymer is present, the recyclable thermoplastic layer comprising TPV and polyethylene may advantageously comprise a dielectric liquid, for example a dielectric oil.

Advantageously, the recyclable thermoplastic layer of the invention comprises a polar compound of the benzophenone type, which further optimizes its dielectric properties. When employed, the polar compound of the benzophenone type is advantageously present in the layer in an amount of 0.1% to 0.5% by weight (for example between 0.2 and 0.4%, in particular of around 0.3% by weight) relative to the total weight of the recyclable thermoplastic layer. Typically, a polar compound of the benzophenone type is employed as a mixture with a dielectric liquid, in particular a dielectric oil. The polar compound (for example benzophenone) is then advantageously premixed with said dielectric liquid before it is incorporated into the polymer composition forming the thermoplastic layer, this premix forming an additized dielectric liquid being particularly well suited to the implementation of the invention.

A cable of the invention is preferably what is referred to as a low-voltage power cable (i.e. intended to convey a voltage current of less than 6 kV) or what is referred to as a medium-voltage power cable (which is intended to convey a voltage current of between 6 and 60 kV).

In the case of a low-voltage power cable, the recyclable thermoplastic layer is typically an insulating layer, preferably internal to said cable.

In the case of a medium-voltage power cable, the cable may comprise one or more recyclable thermoplastic layers of the invention, each of said layers being either an insulating layer or a semiconductive layer. In other words, in the case of a medium-voltage power cable, the recyclable thermoplastic layer of the invention is an insulating layer or a semiconductive layer.

Various aspects and specific embodiments of the invention are described in more detail hereinbelow.

### Composite Material (TPV)

Preferably, the TPV material is present in the recyclable thermoplastic layer of the invention in an amount of 5% to 20% by weight relative to the total weight of said layer.

### Polyethylene

The polyethylene present in the recyclable thermoplastic layer of the invention may in particular be a low-density polyethylene and preferably a linear low-density polyethylene, in particular according to the standard ISO 1183A (at a temperature of 23° C.). In the present invention, the term “linear low-density polyethylene” means a linear polyethylene having a density ranging from about 0.91 to about 0.925, said density being measured according to the standard ISO 1183A (at a temperature of 23° C.).

Irrespective of its nature, the polyethylene is preferably present in the recyclable thermoplastic layer of the invention in an amount of 15% to 30% by weight relative to the total weight of said layer.

The polyethylene/TPV weight ratio, calculated as the ratio of the total weight of polyethylene in the layer relative to the total weight of TPV in the layer, is preferably between 2 and 4, and typically around 2.5 to 3.5, for example 3.

### Propylene Copolymer (c)

The propylene copolymer (c) is an optional compound advantageously present in the thermoplastic layer, where it brings about a further improvement in performance. Said compound (c) is preferably a copolymer of propylene and an alpha-olefin other than propylene.

Said alpha-olefin other than propylene is preferably a compound of formula CH₂═CH—R, where R is a linear or branched alkyl group containing from 2 to 12 carbon atoms, and may in particular be chosen from the following alpha-olefins: ethylene, 1-butene, 1-pentene; 4-methyl-1-pentene, 1-hexene, 1-octene, 1-decene, 1-dodecene, and a mixture thereof.

Irrespective of its exact nature, the alpha-olefin other than propylene (ethylene or another olefin) present in the copolymer (c) accounts preferably for less than 15 mol %, for example between 1 and 10 mol %, relative to the total number of moles of monomer units in the propylene-olefin copolymer.

### Dielectric Liquid and Polar Compounds of the Benzophenone Type

When a dielectric liquid is present in the thermoplastic layer of the invention, this may advantageously be chosen from mineral oils (for example naphthenic oils, paraffinic oils or aromatic oils), vegetable oils (in particular soya, linseed, rapeseed, maize and/or castor oil) or synthetic oils such as aromatic hydrocarbons (alkylbenzenes, alkylnaphthalenes, alkylbiphenyls, alkydiarylethylenes, etc.), silicone oils, ethers, organic esters or aliphatic hydrocarbons.

According to a specific embodiment, the dielectric liquid is present in an amount of from about 0% to about 20% by weight, preferably from about 1% to about 10% by weight and more preferably from about 3% to about 7% by weight, relative to the total weight of the thermoplastic polymer material layer.

The dielectric liquid may advantageously comprise a mineral oil. A mineral oil useful as the dielectric liquid of the invention is generally liquid at least over the temperature range between 20 and 25° C. and advantageously at least over the temperature range between 15° C. and 30° C.

Examples of mineral oils useful as the dielectric liquid of the invention include naphthenic oils, paraffinic oils and mineral oils obtained from refining a petroleum crude.

According to a particularly preferred embodiment of the invention, the mineral oil has a paraffinic carbon (Cp) content ranging from about 45 at % to about 65 at %, a naphthenic carbon (Cn) content ranging from about 35 at % to about 55 at %, and an aromatic carbon (Ca) content ranging from about 0.5 at % to about 10 at %.

In addition, the thermoplastic layer of the invention advantageously comprises at least one polar compound of the benzophenone or acetophenone type or a derivative thereof. The polar compound may then be chosen in particular from benzophenone, acetophenone, dibenzosuberone, fluorenone and anthrone. Benzophenone is particularly preferred.

The dielectric liquid present in the polymer layer of the invention advantageously comprises a mineral oil blend, preferably of the abovementioned type. According to this embodiment, the dielectric liquid may advantageously comprise at least about 70% by weight of mineral oil, and preferably at least about 80% by weight of mineral oil, relative to the total weight of the dielectric liquid. The proportion of polar compound (of benzophenone or acetophenone type or derivative thereof) accounts preferably for at least about 2.5% by weight, preferably at least about 3.5% by weight and even more preferably at least about 4% by weight, relative to the total weight of the dielectric liquid.

### Other Optional Additives

The polymer layer of the invention may advantageously comprise one or more additives other than the abovementioned compounds, for example antioxidants, UV stabilizers, anti-copper agents, water-treeing inhibitors, pigments, and mixtures thereof.

### Power Cables Comprising a Recyclable Thermoplastic Layer of the Invention

A cable employing a recyclable thermoplastic layer of the invention can in particular be:
an electrical cable comprising at least one elongate electrically conductive element surrounded by said recyclable thermoplastic layer, this layer being for example:
an insulating layer (preferably internal to the cable, or alternatively an outer sheath); or
a semiconductive layer.

### Layer Employed as an Insulating Layer

When the recyclable thermoplastic layer of the invention is an electrically insulating layer, it preferably has an electrical conductivity of not more than 1.10⁻⁹ S/m (siemens per metre) at 25° C.

### Layer Employed as a Semiconductive Layer

When the recyclable thermoplastic layer of the invention is a semiconductive layer, it generally comprises an electrically conductive filler, in an amount sufficient to render the polymer composition semiconductive. An example of a highly suitable electrically conductive filler is carbon black.

“Semiconductive layer” is understood here as meaning a layer having an electrical conductivity of at least 1.10⁻⁹ S/m (siemens per metre), preferably at least 1.10⁻³ S/m, and generally less than 1.10³ S/m (at 25° C.).

### Possible Structures for a Cable of the Invention

According to a first possible embodiment, the recyclable thermoplastic layer of the invention can be used in an electrical cable as an insulating layer in direct physical contact with an elongate electrically conductive element. This embodiment is particularly well suited for a low-voltage type cable.

According to another possible embodiment, the electrical device of the invention is an electrical cable comprising a first semiconductive layer surrounding an elongate electrically conductive element, an electrically insulating layer surrounding said first semiconductive layer, and a second semiconductive layer surrounding said electrically insulating layer, and wherein the recyclable thermoplastic layer of the invention is at least one of these three layers, preferably at least two of said three layers, and preferably said three layers. This is then referred to as a medium- or high-voltage cable.

According to the present invention, the elongate electrically conductive element of the electric cable may be a metal wire or a plurality of twisted or untwisted metal wires, in particular of copper or aluminium, or an alloy thereof.

### Creation of a Thermoplastic Layer of the Invention

The recyclable thermoplastic layer of the invention may be an extruded layer or a moulded layer, which may in particular be obtained by extrusion or moulding processes well known to those skilled in the art. The recyclable thermoplastic layer of the invention is preferably an extruded layer. When the electrical device is an accessory for an electrical cable, the crosslinked layer is preferably a moulded layer.

### BRIEF DESCRIPTION OF THE DRAWINGS

The invention will be further illustrated by the FIGURE in the appendix and the illustrative example below.

FIG. 1 shows a schematic view of an electrical cable comprising an insulating thermoplastic layer of the invention.

For the sake of clarity, only the elements essential for the understanding of the invention have been represented schematically, and these are not to scale.

### DETAILED DESCRIPTION

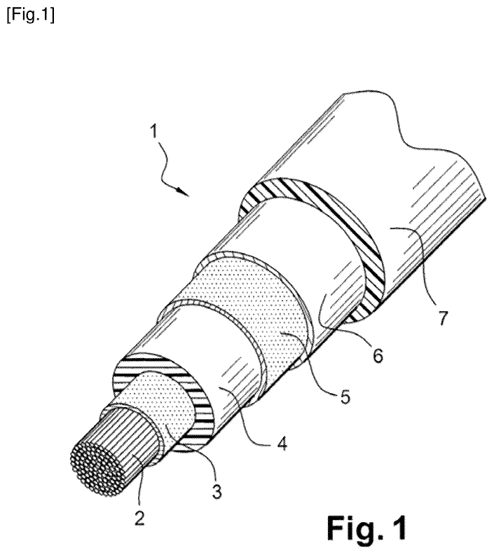

FIG. 1 shows an electrical cable 1, which comprises an elongate central electrically conductive element 2, in particular an element made of copper or aluminium. This electrical cable 1 further comprises a plurality of layers arranged successively and coaxially around this elongate central electrically conductive element 2, namely: a first semiconductive layer 3 referred to as the “inner semiconductive layer”, an electrically insulating layer 4, a second semiconductive layer 5 referred to as the “outer semiconductive layer”, a metal shield for earthing and/or protection 6, and an outer protective sheath 7.

The electrically insulating layer 4 is a recycled thermoplastic layer of the invention obtained by extrusion and comprising a TPV composite material; a polyethylene; advantageously a propylene copolymer (c); and optionally additives of the abovementioned type.

The semiconductive layers 3 and 5 are advantageously recycled extruded thermoplastic layers of the invention comprising a TPV composite material; a polyethylene; advantageously a propylene copolymer (c), optionally additives of the abovementioned type; and an electrically conductive filler (typically a carbon black).

The presence of the metal shield 6 and of the outer protective sheath 7 is preferred, but not essential, this cable structure being a structure of the customary type.

### Example

The following compositions were tested, which include a composite material of the TPV type (commercial product of the Santoprene and OptiPren range based on an EPDM elastomer phase dispersed in a polypropylene matrix); a polyethylene (LLDPE BPD 3642), a propylene-ethylene copolymer (Moplen RP210G), a mineral oil (BNS28), benzophenone (premixed with the oil) and an antioxidant additive (Irganox B225).

By way of comparison, control compositions free of polyethylene and copolymer were tested, in which these compounds were replaced by TPV. In most cases these compositions did not lead to compositions that were employable, because the absence of polyethylene made the incorporation of the oil impossible. Only the control based on Optipren led to a homogeneous polymer composition.

The compositions of the formulas that were tested are stated in Table 1 above (amounts are in parts by weight per 100 parts by weight of the total composition)

TABLE 1
Composition of the compositions tested

| Composition | C1 | C2 | C3 | Control |
|---|---|---|---|---|
| Moplen | 56.6 | | | 0 |
| LLDPE | 28 | | | |
| TPV: | | | | |
| Santoprene 203-40 | 9.4 | | | |
| Santoprene 203-50 | | 9.4 | | |
| OptiPren | | | 9.4 | 94 |

| | |
|---|---|
| Oil | 5.4 |
| Benzophenone | 0.3 |
| Antioxidant | 0.3 |

The performance of the compositions thus prepared is reported in Table 2 below.

TABLE 2
Performance of the compositions tested

| Composition | C1 | C2 | C3 | Control |
|---|---|---|---|---|
| Colour | translucent | translucent | translucent | translucent |

DSC ^{[1]}

| | | | | |
|---|---|---|---|---|
| Melting temperature | 124/147 | 123/146 | 123/144° C. | 155° C. |
| (2nd cycle) | | | | |
| Onset of melting | 118/137 | 119/137 | 119/135° C. | 142° C. |
| temperature | | | | |
| (2nd cycle) | | | | |

Mechanical properties ^{[2]}

| | | | | |
|---|---|---|---|---|
| TSP (MPa) | 31.2 | 28.6 | 31.2 | 16.2 |
| EB (%) | 909 | 909 | 916 | 750 |

Measurements after thermal ageing (after 10 days at 135° C.)

| | | | | |
|---|---|---|---|---|
| ΔTSP | −19% | −12% | −18% | +6% |
| ΔEB | −27 | −23 | −23% | +23% |

Measurement of thermopression ^{[3]}

| | | | | |
|---|---|---|---|---|
| Indentation value | 3 | 2 | 3 | 23 |
| (%) | | | | |

Elongation when cold ^{[4]}

| | | | | |
|---|---|---|---|---|
| Elongation | 687 | 503 | 694 | >800 |
| (%) | | | | |

Water uptake ^{[5]}

| | | |
|---|---|---|
| Weight gain | 0.17 | 0.14 |
| (mg/cm²) | | |

Dielectric spectroscopy ^{[6]}

| | | | | |
|---|---|---|---|---|
| tan (δ) 110° C. | | | 1.22 · 10⁻³ | 2.4 · 10⁻² |
| 90° C. | 4.18 · 10⁻⁴ | 2.4 · 10⁻⁴ | 1.83 · 10⁻⁴ | 1.1 · 10⁻² |
| 70° C. | | | 3.42 · 10⁻⁴ | 2.9 · 10⁻³ |
| 30° C. | 4.97 · 10⁻⁴ | 8.2 · 10⁻⁵ | | 2.9 · 10⁻⁴ |
| Permittivity 110° C. | | | 2.13 | 1.94 |
| 90° C. | 2.22 | 2.22 | 2.20 | 2.00 |
| 70° C. | | | 2.25 | 2.05 |
| 30° C. | 2.33 | 2.33 | 2.31 | 2.13 |

Notes:
^{[1]} DSC measurement under a stream of nitrogen, 3 cycles of temperature rise from −20° C. to +250° C. at a rate of 10° C./min
^{[2]} Measured on the Instron at −250 mm/min - median of 5
^{[3]} Indentation value expressed as a percentage
^{[4]} Measurement at −25° C.
^{[5]} Measurement carried out after treatment for 336 h at 85° C.
^{[6]} Standard = max tan (δ) 30° C. = 4.10⁻³; max tan (δ) 90° C. = 8.10⁻³

1. An electrical cable comprising: at least one elongate conductive element surrounded by a recyclable thermoplastic layer, the recyclable thermoplastic layer comprising at least:
a composite material (TPV) comprising:
(a) a thermoplastic polymer matrix; and
(b) a vulcanized elastomer phase dispersed within said thermoplastic matrix (a); and
a polyethylene.

2. The electrical cable according to claim 1, where the dispersed vulcanized elastomer phase (b) comprises a crosslinked ethylene-propylene-diene elastomer (EPDM).

3. The electrical cable according to claim 1, where the thermoplastic matrix (a) comprises a propylene homopolymer or copolymer.

4. The electrical cable according to claim 1, where the recyclable thermoplastic layer further comprises a copolymer of propylene and an alpha-olefin other than propylene.

5. The electrical cable according to claim 1, where the recyclable thermoplastic layer further comprises a dielectric liquid.

6. The electrical cable according to claim 1, where the recyclable thermoplastic layer further comprises benzophenone.

7. The electrical cable according to claim 1, where the cable is a low-voltage power cable.

8. The electrical cable according to claim 7, where the recyclable thermoplastic layer is an insulating layer.

9. The electrical cable according to claim 1, where the cable is a medium-voltage power cable.

10. The electrical cable according to claim 9, where the recyclable thermoplastic layer is an insulating layer or a semiconductive layer.

11. The electrical cable according to claim 4, where the recyclable thermoplastic layer further comprises a copolymer of propylene and ethylene.
